(19) United States
(12) Patent Application Publication
(10) Pub. No.: US 2012/0171073 A1
(43) Pub. Date: Jul. 5, 2012

(54) ALLOY FOR MAKING GROUNDING ELECTRODES AND CONNECTION METHOD THEREFOR

(76) Inventor: Alberto Manuel Ontiveros Balcazar, Zapopan (MX)

(21) Appl. No.: 13/388,305

(22) PCT Filed: Sep. 21, 2009
(86) PCT No.: PCT/MX2009/000101

§ 371 Date: Feb. 1, 2012

(30) Foreign Application Priority Data
Jun. 10, 2009 (MX) MX/A/2009/006149

(51) Int. Cl. C22C 18/02; B23K 31/02; B23K 37/00; C22C 18/04

(52) U.S. Cl. 420/518; 228/199

(57) ABSTRACT

This invention refers to an alloy for the manufacture of ground-installed electrodes, which is primarily composed of aluminum, manganese, copper, zinc, cadmium, titanium, lead, and iron. This novel alloy allows for the manufacture of vertical and horizontal electrodes of different dimensions, which are used for the ground installation of electrical substations, transmission towers, and electrical distribution posts. In addition, the invention also provides a method to connect said electrodes in a more efficient manner.

### TECHNICAL FIELD

This invention is in the general technical field of mechanics, more specifically, in those metal alloys used to manufacture electrodes that conduct to ground electrical discharges due to variations in current in electrical equipment or from lightning.

Purpose of the invention. To provide a metallic alloy that allows for the production of grounding electrodes with chemical-physical-electrical characteristics comparable to electrodes manufactured in copper. A second purpose is to develop a method that permits quick connection of electrodes, optimizing their installation.

### INVENTION BACKGROUND

For several decades, the material used most often for the manufacture of grounded electrodes has been copper, for its excellent electric conductivity as well as its mechanical properties such as low hardness and high malleability. This metal also has the peculiarity of being able to be processed and reprocessed multiple times without affecting any of the above-mentioned properties; due to this last characteristic, copper has become very expensive on the black market, and is constantly stolen from places such as electrical substations, high-voltage transmission towers, medium-voltage distribution posts, etc., since during the times when these places are under little security, it is easy for thieves to enter and disconnect all the copper cables and electrical connections. To solve this problem, this application proposes a new metal alloy that allows for the creation of electrodes with physical-chemical-electrical characteristics similar to those made with copper, but with the difference that they cannot be reprocessed. Thus they have the same mechanical and electrical function, but are no longer attractive to thieves, since thieves are only interested in copper, which they can sell clandestinely.

In addition, for the state of the art in North American technology, we know about U.S. Pat. No. 5,122,375, which describes a zinc electrode used in alkaline batteries, where said negative zinc electrode has an active material composed of zinc and magnesium; the alloy contains a quantity of magnesium in the range of more than 1% to approximately 15% by weight. The zinc-magnesium also can contain a small amount of an additive that reduces the hydrogen load, or an effective import of a metal additive that increases porosity, such as that of 5 to 25% of weight of aluminum in zinc. The zinc-magnesium alloy is applies in the form of particles in a current collector, using any of a series of conventional methods such as pressing the mix with a filler or polymer and heating, compacting, or sintering. The electrode has a life cycle longer than a conventional zinc oxide one, and causes little or no dendrite formation. The problem this zinc-magnesium alloy presents is that it is harder, which makes manufacture of the electrodes difficult; lastly, it does not meet the minimum electrical requirements nor the standards of the Federal Electricity Commission regarding grounded electrodes.

### DETAILED DESCRIPTION OF THE INVENTION

The characteristic details of this alloy to manufacture grounded electrodes are clearly shown in the following description and in the accompanying figures, which are given as examples and should not be considered limiting.

Description of the figures:

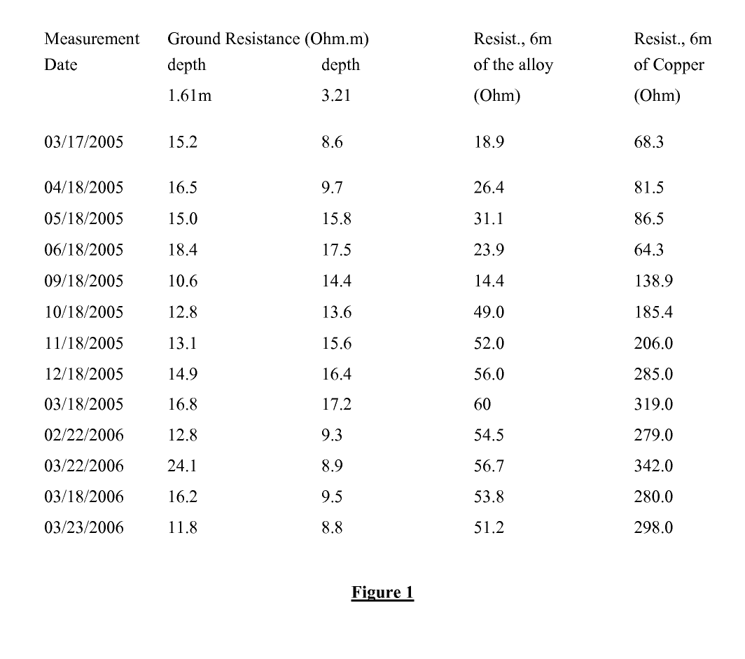

FIG. 1 shows a table with the results of the tests for corrosion speed, dimensional electrical and resistance against time of this alloy to manufacture electrodes.

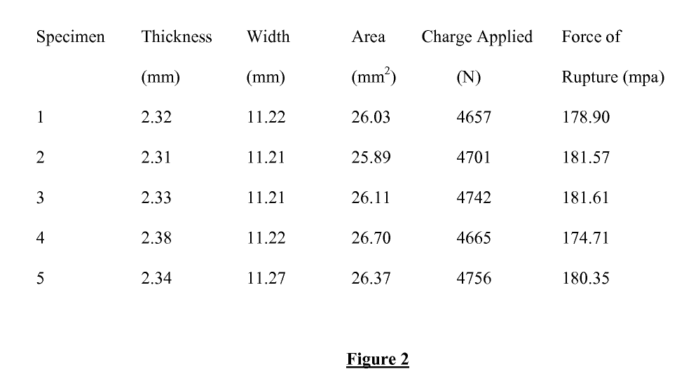

FIG. 2 shows a table with the voltage resistance results for this alloy.

First we will describe the alloy, which consists mainly of:

| No. | Metal | (% weight min) | (% weight max) |
|---|---|---|---|
| 1 | Aluminum | 0.002 | 5.0 |
| 2 | Manganese | 0.002 | 0.010 |
| 3 | Copper | 0.002 | 5.0 |
| 4 | Cadmium | 0.003 | 0.005 |
| 5 | Lead | 0.003 | 0.010 |
| 6 | Iron | 0.002 | 0.010 |
| 7 | Titanium | 0.001 | 0.180 |
| 8 | Zinc | balance | balance |

With this metallic mix, the hydrogen load in the electrodes is minimized, while porosity increases due to the aluminum. In addition, the aluminum, manganese, and titanium can be optionally used in the alloy, with which as already mentioned grounded electrodes are manufactured, where each one is basically a rectangular metallic strip, described as follows:

1.—Vertical electrode joins the connector located in the base of the post or tower that holds the high-voltage cables; this electrode is primarily manufactured in the following dimensions: Width from ¼″ to 1″, thickness in a range of 0.060″ to 0.120″, and length in a range from 3 to 50 feet.
2.—Horizontal electrode goes underground and should be manufactured in the following dimensions: width from 1″ to 3″, thickness 0.060″ to 0.180″ and depth from 3 to 100 feet.

Below, we describe the method to weld grounded electrodes.

Materials for welding grounded electrodes.
1. Alloy strips (vertical and horizontal electrodes, “Conduzinc” brand)
2. Galvanized steel sheet clamp
3. Mold (model CZPA11/2)
4. “Conduweld” load No. 150
5. File, square file, or sandpaper
6. Clips for molds
7. Presses or vises
8. Hammer or mallet
9. Cleaning brush for the mold
10. Putty to seal the mold
11. Lighter
12. Aerosol for cold galvanizing
13. Shears
14. Optional equipment: pliers, vise grips, and screwdrivers
15. Safety glasses and gloves

Method for welding grounded electrodes.

This plan consists basically of cleaning the area to be welded (lower part of the tower or post) with a diamond file, square file, or sandpaper, until the surface has no galvanizing or paint, and is free of any residue that could impair the weld. Next, assemble the clamp with the exothermic graphite mold (mold model No. CZPA 1½), installed and anchored with the security screws. Then, assemble the strip-form electrode with the clamp, cut the length required for the counter-antenna or grounded horizontal electrode, and cut an extra length of approximately 10 cm (wedge). From the length that will be used as an electrode in the next end to be welded, splice it with a zinc galvanized sheet clamp. Next, push one arm of the clamp to begin to close it once it is mostly closed, push the other until it is completely closed, so the clamp remains around the zinc strip; after this, arrange the wedge glued to the structure on the sanded part, and above it move the tip of the electrode with the clamp (with the smooth part remaining in front), and now that it is at this stage, we give the clamp a small turn with the zinc strip. Next, assemble the graphite mold on the electrode strip in the cavity with the mold. Once the mold is assembled, and the zinc is in position with a vise or press at the level of the zinc cavity, attach it until the spaces on the sides are closed. With another vise, close the mold for security, and apply putty to seal the mold. Prepare the “Conduweld” No. 150 load, separating the seal disc and the primer. Discharge the complete load on the seal disc first so as not to move it. Open the primer and spread it on the load and on the mold nozzle. Close the mold opening. Light the starter with the lighter to make the weld. Let it rest 10 to 20 seconds. Remove the vises or presses and remove the mold. Remove any remaining residue with the cleaning brush. Review the weld to make sure it is successful. Proceed to cold galvanization.

The alloy to manufacture grounded electrodes provides the following benefits:
High conductivity.
Low hardness.
High malleability.
Low corrosion speed.
High resistance against time.
Excellent voltage resistance.
No formation of dendrites in the electrodes.
Not susceptible to theft, unlike copper.
Meets CFE specifications.
Meets CFE—LAPEM tests.
Cheaper than traditional copper systems.
Better cost/benefit yield.

Having adequately described my invention, I consider it novel and thus claim the following as my exclusive property:

1. Alloy for manufacturing ground electrodes, characterized in that it consists of a minimum percentage by weight of the following metals: aluminum 0.002, manganese 0.002, copper 0.002, cadmium 0.003, lead 0.003, iron 0.002, titanium 0.001, and the remainder zinc.

2. Alloy to manufacture grounded electrodes, characterized in that it consists of a maximum percentage by weight of the following metals: aluminum 5.0, manganese 0.010, copper 5.0, cadmium 0.005, lead 0.010, iron 0.010, titanium 0.180, and the remainder zinc.

3. Vertical grounded electrode, characterized in that it should preferably be manufactured with the alloy mentioned in claims 1 and 2, in the following dimensions: width in a range from ¼″ to 1″, thickness in a range from 0.060″ to 0.120″, and length in a range from 3 to 50 feet.

4. Horizontal grounded electrode, according to claim 1, characterized in that it should preferably be manufactured with the alloy mentioned in claims 1 and 2, in the following dimensions: width in a range from 1″ to 3″, thickness in a range from 0.060″ to 0.180″, and length in a range from 3 to 100 feet.

5. Method for welding manufactured grounded electrodes characterized in the following steps:
Cleaning the surface to be welded with sandpaper until the surface has no galvanizing or paint, and is free of any residue that could impair the weld.
Assemble the clamp with the exothermic graphite mold (mold model No. CZPA 1½), installed and anchored with the security screws;
Assemble the horizontal and vertical electrodes with a clamp, then cut the length required for the counter-antenna or grounded horizontal electrode, and cut an extra length that will act as a wedge; for the length that will be used as an electrode in the next end to be welded, splice it with a zinc galvanized sheet clamp.
Push one arm of the clamp to begin to close it once it is mostly closed, push the other until it is completely closed, and thus the clamp remains around the zinc strip.
Arrange the wedge glued to the structure on the sanded part, and above it arrange the tip of the electrode, with the clamp, ensuring that the smooth part remains in front, and once it is this position, give the clamp a small turn with the electrode strip.
Next, assemble the graphite mold on the electrode strip in the cavity with the mold.
Close the mold with another vise for security, and apply putty to seal the mold.
Prepare the “Conduweld” No. 150 load, separating the seal disc and the primer.
Insert the seal disc into the unmolded interior and discharge the complete load on the seal disc first so as not to move it.
Open the primer and spread it on the load and on the mold nozzle.
Close the mold opening and light the starter with the lighter to make the weld.
Let it rest 10 to 20 seconds, then remove the vises or presses and remove the mold. Later, remove any remaining residue with the cleaning brush.
Review the weld to make sure it is successful.
Cold galvanization thereof.
